(19) United States
(12) Patent Application Publication
(10) Pub. No.: US 2015/0378083 A1
(43) Pub. Date: Dec. 31, 2015

(54) SPREAD ILLUMINATING APPARATUS

(71) Applicant: MINEBEA CO., LTD., Kitasaku-gun (JP)

(72) Inventor: Kenta TAKAKUSAKI, Fukuroi-shi (JP)

(21) Appl. No.: 14/573,464

(22) Filed: Dec. 17, 2014

(30) Foreign Application Priority Data
Jun. 30, 2014 (JP) 2014-134881

(51) Int. Cl. F21V 8/00

(52) U.S. Cl. CPC G02B 6/0043; G02B 6/0046; G02B 6/0026

(57) ABSTRACT

A spread illuminating apparatus includes a light source that emits white light, and a light guide plate including an incident light surface which is an end surface at which the light source is disposed and an emitting part that emits light which has entered from the incident light surface in a spread pattern from an emitting surface. The light guide plate includes an incident light wedge part between the incident light surface and the emitting part, the incident light wedge part including an inclined surface and tapering in thickness from the incident light surface side toward a forward direction. Also, a blue light diffusing part that scatters mainly blue light by Rayleigh scattering is provided on at least one of the emitting surface side or an opposite surface side of the emitting surface side near the incident light wedge part.

### BACKGROUND OF THE INVENTION

1. Field of the Invention

The present invention relates to a sidelight-type spread illuminating apparatus including a light guide plate that has a light source disposed at an incident light end surface thereof and emits illumination light in a spread pattern from an emitting part.

2. Description of the Related Art

As an illumination unit for a liquid crystal display panel, a sidelight-type spread illuminating apparatus (backlight) in which a light source that emits white light is disposed along a side end surface of a light guide plate is widely utilized. There have been efforts in the past to make such spread illuminating apparatuses thinner and brighter and improve their brightness uniformity and the like. However, recently there has been increased demand for further enhancements to the color tone uniformity of emitted light in accordance with advancements in high definition of liquid crystal display panels. Conventionally, with regard to color tone uniformity, most developments have been exclusively geared towards measures for eliminating color unevenness that occurs across the entire emitting surface of the light guide plate (for example, refer to Japanese Patent Application Laid-Open (JP-A) No. 2005-347010 and Japanese Patent Application Laid-Open (JP-A) No. 2012-94283).

### SUMMARY OF THE INVENTION

However, color unevenness that occurs partially on the light guide plate due to recent reductions in the thickness of light guide plates has emerged as a new problem. In particular, mainly in the field of compact mobile information devices such as mobile telephones, the following light guide plates are currently in wide use. That is, thickness of each emitting portion of the light guide plates is decreased regardless of the thickness of an LED by forming a wedge part. The wedge part, which is formed between the incident light surface and the emitting part, has thickness that tapers off as moving away from the side end surface at which the light source is disposed (hereinafter referred to as the “incident light surface”). However, in such light guide plates, it has been discovered that light emitted from a region of the emitting part closer to the incident light wedge part exhibits a yellow color, and this causes visible color unevenness to occur.

The present invention was created in consideration of the above-described problems, and an object thereof is to provide a spread illuminating apparatus that suppresses any color unevenness that occurs partially on an incident light surface side of a light guide plate and achieves excellent color tone uniformity of emitted light.

The embodiments of the invention described below are examples of the structure of the present invention. In order to facilitate the understanding of the various structures of the present invention, the explanations below are divided into aspects. Each aspect does not limit the technical scope of the present invention, and the technical scope of the present invention can also include structures in which a portion of the components in the aspects below is substituted or deleted, or another component is added upon referring to the best modes for carrying out the invention.

According to a first aspect of the present invention, a spread illuminating apparatus includes: a light source that emits white light, and a light guide plate including an incident light surface which is an end surface at which the light source is disposed and an emitting part that emits light which has entered from the incident light surface in a spread pattern from an emitting surface which is one principal surface, wherein the light guide plate includes an incident light wedge part between the incident light surface and the emitting part, the incident light wedge part including an inclined surface tapering in thickness from the incident light surface side toward a forward direction, and a blue light diffusing part that scatters mainly blue light by Rayleigh scattering is provided on at least one of the emitting surface side or an opposite surface side of the emitting surface side near the incident light wedge part.

With this structure, by providing a blue light diffusing part that scatters mainly blue light by Rayleigh scattering on at least one of an emitting surface side or an opposite surface side of the emitting surface side near the incident light wedge part, blue light that is emitted upon being scattered by the blue light diffusing part is supplemented into the light that is emitted from a region of the emitting part closer to the incident light wedge part. Thereby, visible light unevenness caused by the region of the emitting part closer to the incident light wedge part exhibiting a yellow tint can be suppressed, and in turn, the color tone uniformity of light emitted from the light guide plate can be enhanced.

Further, according to the first aspect of the invention, the blue light diffusing part includes fine bumps which are smaller than the wavelength of blue light.

With this structure, the blue light diffusing part includes fine bumps which are smaller than the wavelength of blue light, and these fine bumps effectively cause Rayleigh scattering. Thereby, blue light can be scattered at a higher scattering intensity compared to light of longer wavelengths than that of blue light.

Further, according to the first aspect of the invention, the maximum height of the fine bumps is smaller than the wavelength of blue light.

With this structure, the maximum height of the fine bumps is smaller than the wavelength of blue light, and these fine bumps more reliably cause Rayleigh scattering. Thereby, the amount of blue light that is scattered by the blue light diffusing part can be further increased.

Further, according to the first aspect of the invention, the blue light diffusing part is provided along an end of an effective emitting region on the incident light surface side when viewed from the top surface.

With this structure, by providing the blue light diffusing part along the end of the effective emitting region on the incident light surface side when viewed from the top surface, the color tone uniformity of light emitted from the effective emitting region, which is important for the quality of illumination light, can be effectively enhanced.

Further, according to the first aspect of the invention, a transition region is configured as that a surface area density of portions in which the fine bumps are formed gradually decreases as moving away from the incident light surface.

With this structure, by providing a transition region in which the surface area density of the portions in which fine bumps are formed gradually decreases as moving away from the incident light surface, sudden changes in the chromaticity of light emitted from the emitting surface near a boundary between the region of the emitting part in which the blue light diffusing part is provided and the region of the emitting part in which the blue light diffusing part is not provided are suppressed. Thereby, the color tone uniformity of emitted light can be further enhanced.

Further, according to the first aspect of the invention, the blue light diffusing part is formed by molding the light guide plate using a die in which a laser beam has been irradiated on a region corresponding to the blue light diffusing part.

With this structure, the blue light diffusing part is formed by molding the light guide plate using a die in which a laser beam has been irradiated on a region corresponding to the blue light diffusing part. Thus, by controlling the power, irradiation time, and irradiation region of the laser beam irradiated during processing of the die, a blue light diffusing part having the desired scattering characteristics corresponding to the desired chromaticity can be easily formed.

Further, according to the first aspect of the invention, the light source includes a light-emitting element and fluorescent bodies, the fluorescent bodies being configured to receive light that is emitted by the light-emitting element, and the fluorescent bodies are allowed to emit light that is different from the light that has been emitted by the light-emitting element.

With this structure, light unevenness of the region of the emitting part closer to the incident light wedge part can be suppressed by the blue light diffusing part provided on at least one of an emitting surface side or an opposite surface side of the emitting surface side near the incident light wedge part, and an inexpensive white light source that generates quasi-white light from a light-emitting element and fluorescent bodies can be used.

Further, according to the first aspect of the invention, the light-emitting element is a blue light-emitting diode that emits blue light, and the fluorescent bodies are yellow fluorescent bodies that emit yellow light.

With this structure, light unevenness of the region of the emitting part closer to the incident light wedge part can be suppressed by the blue light diffusing part provided on at least one of an emitting surface side or an opposite surface side of the emitting surface side near the incident light wedge part, and an inexpensive white LED that generates quasi-white light from a blue light-emitting diode and yellow fluorescent bodies can be used.

Further, according to the first aspect of the invention, the fluorescent bodies are dispersed in an enclosure that covers the light-emitting element.

With this structure, light unevenness of the region of the emitting part closer to the incident light wedge part can be suppressed by the blue light diffusing part provided on at least one of an emitting surface side or an opposite surface side of the emitting surface side near the incident light wedge part, and an inexpensive white light source in which fluorescent bodies are dispersed in an enclosure that covers a light-emitting element can be used.

Further, according to the first aspect of the invention, a plurality of prisms extending from the incident light surface side of the emitting part toward an end surface side opposing the incident light surface are provided on the emitting surface side of the light guide plate.

In general, in a spread illuminating apparatus in which a plurality of prisms (hereinafter also referred to as “longitudinal prisms”) extending from the incident light surface side of the emitting part toward the end surface side opposing the incident light surface, the occurrence of bright lines can be suppressed and the brightness uniformity can be increased even if a point light source is used as a light source. On the other hand, a yellow tint of light emitted from the region of the emitting part closer to the incident light wedge part tends to become stronger. However, with the above structure, by providing the blue light diffusing part that scatters mainly blue light by Rayleigh scattering, the strong yellow tint can be effectively suppressed and the color tone uniformity of emitted light as well as the brightness uniformity can be enhanced.

According to a second aspect of the present invention, a spread illuminating apparatus includes: a light source that includes a light-emitting diode and fluorescent bodies, the light source emitting white light, and a light guide plate including an incident light surface which is an end surface at which the light source is disposed and an emitting part that emits light which has entered from the incident light surface in a spread pattern, the light being emitted from an emitting surface which is one principal surface, wherein the light guide plate comprises an incident light wedge part between the incident light surface and the emitting part, the incident light wedge part including an inclined surface tapering in thickness from the incident light surface side toward a forward direction, and a light diffusing part that scatters mainly light emitted by the light-emitting diode more than light emitted by the fluorescent bodies is provided on at least one of the emitting surface side or an opposite surface side of the emitting surface side near the incident light wedge part.

According to the present invention, with the above structures, a spread illuminating apparatus that suppresses any color unevenness that occurs partially on an incident light surface side of a light guide plate and achieves excellent color tone uniformity of emitted light can be provided.

### BRIEF DESCRIPTION OF DRAWINGS

FIG. 1 is a side cross-section view schematically illustrating the essential parts of a spread illuminating apparatus according to one embodiment of the present invention;

FIG. 2 is a cross-section view along line A-A of the spread illuminating apparatus shown in FIG. 1;

FIG. 3 illustrates one example of a method for forming a blue light diffusing part of the spread illuminating apparatus according to one embodiment of the present invention;

FIG. 4 illustrates one example of a transition region of the blue light diffusing part of the spread illuminating apparatus according to one embodiment of the present invention, wherein FIG. 4A is a graph illustrating the surface area density of a rough surface part relative to a distance in a light guide direction from a position in the blue light diffusing part that is closest to the incident light surface side, and FIG. 4B schematically illustrates one example of an embodiment of the transition region;

FIG. 5 is an enlarged view of a portion of the blue light diffusing part of the spread illuminating apparatus according to one embodiment of the present invention;

FIG. 6 is a graph illustrating the color of light emitted at a measurement point closest to the incident light surface side of the effective emitting region on the light guide plate as coordinates (x, y) on an xy chromaticity diagram of the CIE color specification in the spread illuminating apparatus according to one embodiment of the present invention and a spread illuminating apparatus according to a comparative embodiment;

FIG. 7 is a graph illustrating a chromaticity difference from a chromaticity at a reference point of emitted light across the effective emitting region on the light guide plate relative to a distance in the light guide direction from a position in the effective emitting region that is closest to the incident light surface side in the spread illuminating apparatus according to one embodiment of the present invention and a spread illuminating apparatus according to a comparative embodiment;

FIGS. 8A to 8C illustrate the results upon measuring the color of emitted light at multiple measurement points on a light guide plate using a spread illuminating apparatus according to a reference example of the present invention, wherein FIG. 8A is a schematic view illustrating the essential structure of the spread illuminating apparatus used for the measurements, FIG. 8B is a graph illustrating the x coordinate value on an xy chromaticity diagram of the CIE color specification system relative to a distance in a light guide direction from a position in an effective emitting region that is closest to the incident light surface side, and FIG. 8C is a graph illustrating the y coordinate value on an xy chromaticity diagram of the CIE color specification system relative to a distance in a light guide direction from a position in an effective emitting region that is closest to the incident light surface side;

FIG. 9 is a graph illustrating a relationship between a tapering ratio of a light guide plate and an incident light chromaticity difference and a leaked light ratio in the spread illuminating apparatus according to a reference example of the present invention; and

FIG. 10 is a cross-section view illustrating the structure of an LED which is a light source of the spread illuminating apparatus according to a reference example of the present invention and the spread illuminating apparatus according to one embodiment of the present application.

### DETAILED DESCRIPTION

A spread illuminating apparatus according to an embodiment of the present invention will be explained below referring to the drawings. In the attached drawings, the shape, dimensions, etc. of each constituent element are appropriately exaggerated in order to facilitate the understanding of the present invention. Also, in the attached drawings, if spaces are illustrated between two adjacent constituent elements, such spaces have been inserted or exaggerated in order to facilitate the understanding of the present invention, and the structure of the present invention should not be construed as limited by the presence/absence of such spaces between adjacent constituent elements or the dimensions of such spaces if they exist.

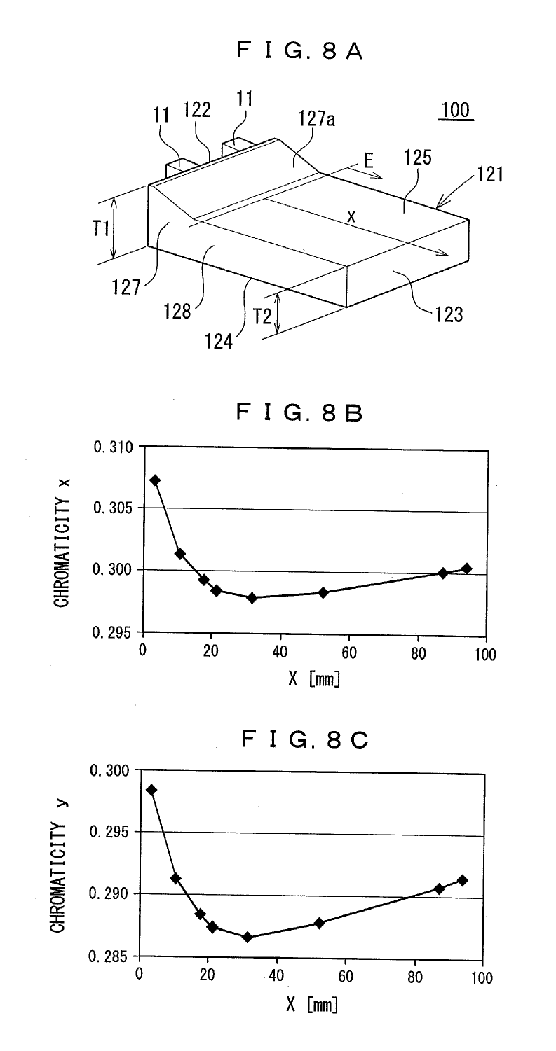

First, the research process that the inventors followed to reach the present invention will be explained in order to facilitate the understanding of the spread illuminating apparatus according to the present invention. The mechanism by which partial color unevenness on the light guide plate occurs, which is a problem of the present invention, will now be described in detail as follows referring to FIGS. 8 to 10. Herein, FIGS. 8A to 8C illustrate the results upon measuring with a color brightness photometer the color of emitted light at multiple measurement points on a light guide plate 121 using a spread illuminating apparatus 100 according to a reference example of the present invention. As shown in FIG. 8A, in the light guide plate 121 of the spread illuminating apparatus 100, an incident light wedge part 127 having an inclined surface 127a is provided between an incident light surface 122 at which LEDs 11 are disposed and an emitting part 128 having an emitting surface 125. Although omitted from the drawings, the LEDs 11 are mounted on an FPC (Flexible Printed Circuit Board), and a portion of the FPC in front of the LEDs (a range covering the inclined surface 127a and a region of the emitting surface 125 closer to the inclined surface 127a) is painted black. Also, an effective emitting region E is defined on the emitting surface 125, and a light blocking means is provided in regions on the emitting surface 125 side of the light guide plate 121 outside the range of the effective emitting region E. The measurement of the color of emitted light was conducted within the range of the effective emitting region E.

In the graph shown in FIG. 8B, the vertical axis is an x coordinate value on an xy chromaticity diagram of the CIE color specification system (hereinafter also referred to as “chromaticity x”), and the horizontal axis is a distance X [mm] in a light guide direction (direction from the incident light surface 122 toward an opposing end surface 123) from a position in the effective emitting region E of the light guide plate 121 that is closest to the incident light surface 122 side as a starting point. In the graph shown in FIG. 8C, the vertical axis is a y coordinate value on an xy chromaticity diagram of the CIE color specification system (hereinafter also referred to as “chromaticity y”), and the horizontal axis is a distance X [mm] in the light guide direction from a position in the effective emitting region E of the light guide plate 121 that is closest to the incident light surface 122 side as a starting point. In FIGS. 8B and 8C, the range shown on the horizontal axis corresponds to approximately the entire length of the effective emitting region E of the light guide plate 121. Further, the measurement points are located approximately in the center in the width direction of the light guide plate 121.

As can be understood from FIGS. 8B and 8C, the chromaticity x and the chromaticity y both increase sharply as X approaches the starting point from near 30 mm, and this sharp increase in both of the chromaticity x and the chromaticity y indicates an increase in the yellow color of the emitted light. Thereby, in the spread illuminating apparatus 100, color unevenness is visible as yellow color on the incident light surface 122 side in the light emitted from the effective emitting region E of the light guide plate 121 (hereinafter, this kind of color unevenness will also be referred to as incident light color unevenness).

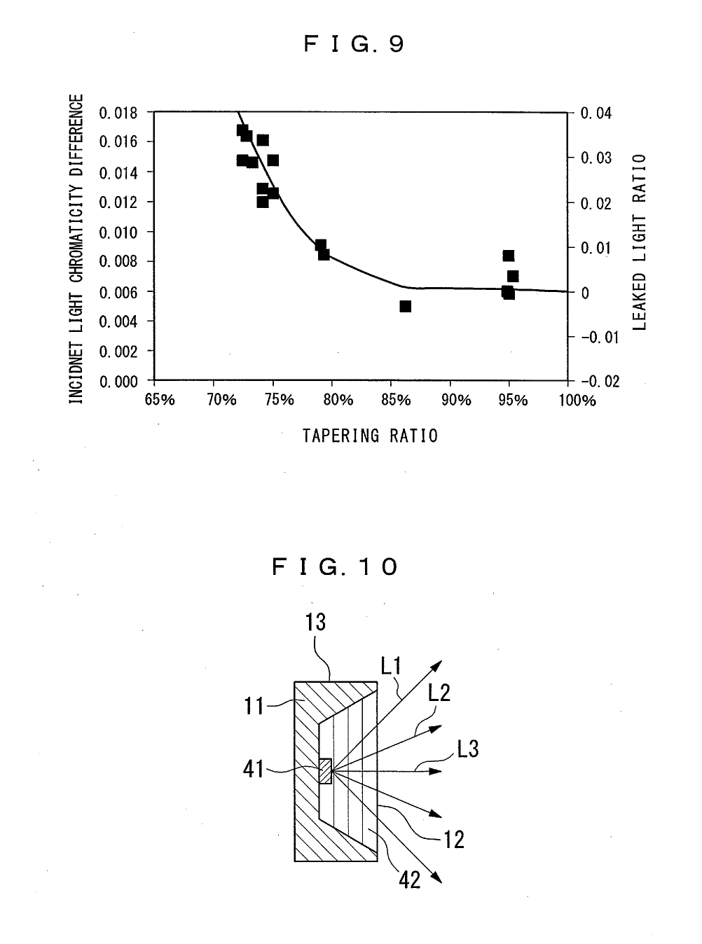

Furthermore, in their investigation and research, the inventors (the applicants) also made the following discoveries regarding the relationship between incident light color unevenness and the shape of the light guide plate 121. FIG. 9 is a graph illustrating a relationship between a tapering ratio of the light guide plate 121 and an incident light chromaticity difference and a leaked light ratio. Herein, the tapering ratio of the light guide plate 121 is a ratio (T2/T1) of a minimum thickness T2 of the incident light wedge part 127 (corresponding to the thickness of the emitting part 128) relative to a maximum thickness T1 of the incident light wedge part 127 (corresponding to the thickness of the incident light surface 122). According to this definition, when the length in the light guide direction of the incident light wedge part 127 is fixed, the inclination angle of the inclined surface 127a of the incident light wedge part 127 increases as the tapering ratio decreases.

The incident light chromaticity difference is an indicator defined as follows for evaluating the incident light color unevenness. Basically, the incident light chromaticity difference is defined as a maximum value of a distance on the xy chromaticity diagram between the chromaticity at a measurement point that is closest to the incident light surface 122 side and the chromaticity at another measurement point. Specifically, when the coordinates on the xy chromaticity diagram of the chromaticity at a measurement point (hereinafter referred to as “P0”) that is closest to the incident light surface 122 side are (x0, y0) and the coordinates on the xy chromaticity diagram of the chromaticity at a measurement point other than P0 are (xi, yi), the incident light chromaticity difference is the maximum value of a distance Δxyᵢ on the xy chromaticity diagram calculated by Δxyᵢ=√((x0−xi)²+(y0−yi)²) for each measurement point other than P0. It can be said that the incident light color unevenness increases as the incident light chromaticity difference defined as above increases.

Also, the leaked light ratio is a ratio (L/I) of an amount of leaked light L that has leaked from the incident light wedge part 127 relative to an amount of incident light I that has entered into the light guide plate 121.

In FIG. 9, the incident light chromaticity difference measured at various tapering ratios is plotted with black-filled square shapes, and the relationship between the tapering ratio and the leaked light ratio is illustrated with a solid line. Also, the measurement was carried using light guide plates 121 in which the tapering ratios were different but the length in the light guide direction of the incident light wedge part 127 was fixed.

From FIG. 9, it can be understood that there is a strong correlation between the tapering ratio of the light guide plate 121 and the incident light chromaticity difference. In particular, it can be understood that if the tapering ratio drops below 85%, the incident light chromaticity difference increases as the tapering ratio decreases. In other words, if the inclination angle of the inclined surface 127a of the incident light wedge part 127 increases above a predetermined value corresponding to a tapering ratio of 85%, the incident light color unevenness becomes prominent as the inclination angle of the inclined surface 127a increases. Also, from FIG. 9, it can be understood that the correlation between the tapering ratio and the incident light chromaticity difference is similar to the relationship between the tapering ratio and the leaked light ratio. The measurements indicating the results in FIGS. 8B and 8C were conducted using a light guide plate 121 with a tapering ratio of 73%, and the incident light chromaticity difference thereof was 0.015.

Through their keen research, the present inventors (the present applicant) discovered the following regarding the mechanism by which incident light color unevenness occurs. In general, light emitted from a region on the incident light surface 122 side among light emitted from the effective emitting region E of the light guide plate 121 is emitted from the LEDs 11 and enters into the light guide plate 121 from the incident light surface 122, and then is reflected one or more times between the emitting surface 125 side and an underside surface 124 side of the light guide plate 121 while it is guided through the incident light wedge part 127 and through a region of the emitting part 128 closer to the incident light wedge part 127. As a result, this light enters into the emitting surface 125 at an incident angle that is smaller than a critical angle on the incident light surface 122 side of the effective emitting region E of the emitting surface 125, and it is thereby emitted from this position.

However, as shown in FIG. 10, the LEDs 11 used as a light source in the spread illuminating apparatus 100 have a structure in which a blue light-emitting diode 41 is enclosed in a transparent resin 42 in which yellow fluorescent bodies are dispersed. An emission spectrum that appears white (quasi-white) is realized by the mixture of blue light emitted by the blue light-emitting diode 41 and yellow light emitted by the yellow fluorescent bodies which have absorbed the blue light.

Therein, the distance over which a light L1, which is emitted from the LEDs 11 in a direction in which the angle that forms the optical axis thereof is large, passes through the transparent resin 42 is longer compared to that of a light L2 and a light L3, which are emitted from the LEDs 11 in a direction in which the angle that forms the optical axis thereof is small. Thus, the light L1 is a white light that exhibits a stronger yellow tint compared to the lights L2 and L3. This light L1, which is emitted from the LEDs 11 in a direction in which the angle that forms the optical axis thereof is large and has a strong yellow tint, enters directly, or after being reflected once at the underside surface 124, into the inclined surface 127a of the incident light wedge part 127 at a small incident angle. Thus, this light L1 subsequently follows the optical path described above without being directly guided into the emitting part 128 so as to be emitted from the incident light surface 122 side of the effective emitting region E of the emitting surface 125. On the other hand, the lights L2 and L3 (exhibiting a stronger blue tint than the light L1), which are emitted in a direction in which the angle that forms the optical axis thereof is small, enter into the emitting surface 125 at an incident angle that is larger than a critical angle on the incident light surface 122 side of the effective emitting region E of the emitting surface 125. As a result, these lights L2 and L3 are further guided through the emitting part 128 toward the opposing end surface 123 and then emitted from the emitting surface 125. This is believed to be one mechanism that leads to the occurrence of incident light color unevenness.

For example, if the tapering ratio of the light guide plate 121 decreases and the inclination angle of the inclined surface 127a of the incident light wedge part 127 increases, the angular change when reflecting at the inclined surface 127a increases. Therefore, it is anticipated that the incident light color unevenness arising from the above mechanism would also increase, and this is also illustrated in the correlation between the tapering ratio and the incident light chromaticity difference shown in FIG. 9.

An LED 11 having a structure like that shown in FIG. 10 is widely for industrial and general illumination. Thus, suppressing the occurrence of incident light color unevenness that accompanies the use of such an LED 11 is a very important problem. However, incident light color unevenness is also believed to occur in light sources having other structures. For example, in an LED in which fluorescent bodies of a color other than yellow (such as red and green) having a wavelength that is longer than blue light are dispersed in a transparent resin enclosing a blue light-emitting diode, it is believed that incident light color unevenness occurs due to the same mechanism as that in the LED 11.

Further, incident light color unevenness is also believed to be promoted by the wavelength dispersibility of the refractive index of an optical resin material that constitutes the light guide plate 121. Basically, the refractive index of a resin material exhibits wavelength dispersibility in which the refractive index decreases as the wavelength of light increases. In turn, the critical angle increases as the wavelength increases. Therefore, it can be said that light components having a wavelength that is longer than that of a blue light component among light that enters at a specific incident angle into the incident light surface 122 side of the effective emitting region E of the emitting surface 125 are more easily emitted at that position than a blue light component. In other words, if the specific incident angle is larger than a critical angle relative to blue light but is smaller than a critical angle relative to light having a wavelength that is longer than that of blue light, the blue light component is completely reflected and further guided through the light guide plate 121 toward the opposing end surface 123, but the light components having a wavelength that is longer than that of blue light (for example, the light components of a range from red light to green light including yellow light) are emitted from that position. It is believed that this mechanism is also a factor leading to the occurrence of incident light color unevenness.

Incident light color unevenness caused by wavelength dispersibility of the refractive index of an optical resin material can occur in nearly all white light sources, including light sources consisting of a combination of light-emitting elements (such as a diode) of, for example, red light, green light, blue light, and the like.

In the spread illuminating apparatus 100 used in the measurements indicating the results in FIGS. 8 and 9, a portion of the FPC in front of the LEDs 11 is painted black in order to absorb light that has leaked from the inclined surface 127a and the region of the emitting surface 125 closer to the inclined surface 127a. However, in general, the spread illuminating apparatus can also have a structure in which a portion of the FPC in front of the LEDs 11 is painted white so as to reflect light that has leaked from the inclined surface 127a and the region of the emitting surface 125 closer to the inclined surface 127a and return it into the light guide plate 121. The reason that an FPC in which the portion in front of the LEDs 11 is painted black was utilized in the spread illuminating apparatus 100 used in the above-mentioned measurements is as follows.

Basically, if an FPC in which the portion in front of the LEDs 11 is painted white is utilized, most of the light that is reflected by the white-painted portion and returned into the light guide plate 121 follows the above-described optical path and is emitted from the incident light surface 122 side of the effective emitting region E of the emitting surface 125. Therefore, if this structure is utilized in the case that the amount of light that has leaked from the inclined surface 127a and the region of the emitting surface 125 closer to the inclined surface 127a is comparatively large, a so-called hot spot will occur on the incident light surface 122 side of the effective emitting region E, and thus good brightness distribution cannot be obtained. Further, since the leaked light also includes light with a strong yellow tint, returning the light that has leaked from the inclined surface 127a into the light guide plate 121 with no wavelength dependence by the white-painted portion of the FPC may become a factor that exacerbates the incident light color unevenness.

Recently, under the strong demand for decreasing the thickness of light guide plates, it has become common to decrease the thickness of the emitting part 128 by decreasing the tapering ratio. For example, there has been a tendency to decrease the tapering ratio to less than 80%. Under these circumstances, it has become increasingly vital to solve the problem of incident light color unevenness.

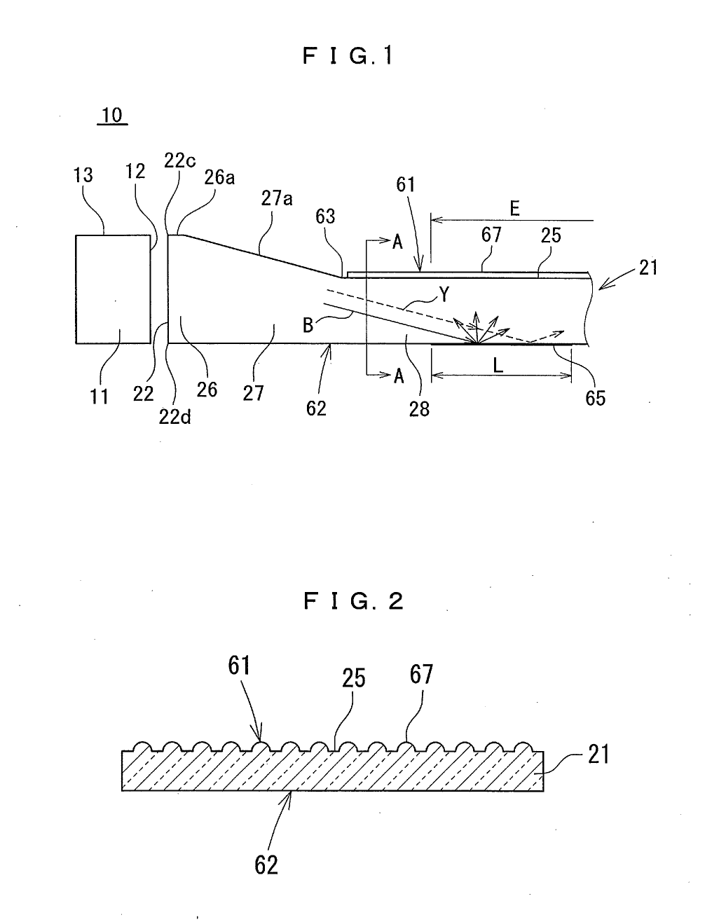

The present inventors reached the present invention as a result of the diligent research described above. Hereinafter, a spread illuminating apparatus 10 according to one embodiment of the present invention will be explained. As shown in FIG. 1, the spread illuminating apparatus 10 includes LEDs 11 as light sources which emit white light, and a light guide plate 21 for emitting light emitted by the LEDs 11 in a spread pattern. Although omitted from the drawings, the LEDs 11 are normally mounted on an FPC (Flexible Printed Circuit Board).

In the present embodiment, each LED 11 is a so-called side view type LED that is formed in an overall rectangular parallelepiped shape and has a light emitting surface 12 on one side surface thereof. In other words, in each LED 11, a surface (for example, a surface 13; hereinafter referred to as the “bottom surface”) that is mounted on the FPC is substantially orthogonal to the light emitting surface 12. As shown in FIG. 10, each LED 11 has a structure in which a blue light-emitting diode 41, which is a light-emitting element, is enclosed in a transparent resin (enclosure) 42 in which yellow fluorescent bodies are dispersed. Therein, an emission spectrum that appears white (so-called quasi-white) is realized by the mixture of blue light emitted by the blue light-emitting diode 41 and yellow light (of a wavelength longer than that of blue light) emitted by the yellow fluorescent bodies which have absorbed the blue light.

In the present embodiment, a plurality of the LEDs 11 are disposed with predetermined intervals therebetween along the lengthwise direction (the direction orthogonal to the paper surface in FIG. 1) of the incident light surface 22 in a state in which the light emitting surface 12 of each LED 11 is facing the incident light surface 22 (to be explained later) of the light guide plate 21.

The light guide plate 21 is formed in a rectangular shape when viewed from the top surface using a transparent material (for example, a polycarbonate resin). On its outer surface, the light guide plate 21 includes the incident light surface 22, which is an end surface at which the LEDs 11 are disposed. In the light guide plate 21, an emitting surface 25 and an inclined surface 27a (to be explained later) are included on a surface of the light guide plate 21 that is connected to one edge (22c) among the two edges 22c and 22d in the lengthwise direction of the incident light surface 22. Hereinafter, the surface of the light guide plate 21 which includes the emitting surface 25 will be referred to as a top surface 61, and the surface on the opposite side of the top surface 61 will be referred to as an underside surface 62.

Herein, in the present invention, a direction from the incident light surface 22 toward the end surface (omitted from the drawings) opposing the incident light surface 22 (the rightward direction on the paper surface in FIG. 1) will be referred to as the “forward (or light traveling)/front” direction (the opposite direction will be referred to as the “backward/back”

direction). The “forward/front” direction as defined in this way is also the overall direction in which light that has entered from the incident light surface 22 into the light guide plate 21 is guided through the light guide plate 21. Thus, in these terms, the front-back direction defined as above will also be referred to as the “light guide direction”.

A direction in which the underside surface 62 faces the top surface 61 (the upward direction on the paper surface in FIG. 1) will be defined as the “upward” direction (the opposite direction will be defined as the “downward” direction), and the up-down direction according to these definitions will also be referred to as the “thickness direction”. Further, a direction orthogonal to the front-back direction and the up-down direction (the direction orthogonal to the paper surface in FIG. 1) will be referred to as the left-right direction (if necessary, “rightward” and “leftward” are defined facing the forward direction). In other words, the left-right direction is the lengthwise direction of the incident light surface 22. Further, unless explicitly stated otherwise, the terms “length”, “thickness” or “height”, and “width” refer respectively to the dimensions in the front-back direction, the up-down direction, and the left-right direction.

The light guide plate 21 includes a flat part 26 formed in the forward direction from the incident light surface 22, an incident light wedge part 27 that is formed connected to the flat part 26 and includes the inclined surface 27a, and an emitting part 28 that is formed in the forward direction connected to the incident light wedge part 27 and emits light from the LEDs 11 that has been guided through the incident light wedge part 27 in a spread pattern from the emitting surface 25. The underside surface 62 of the light guide plate 21 is formed in a single flat surface throughout the flat part 26, the incident light wedge part 27, and the emitting part 28. Meanwhile, the inclined surface 27a of the incident light wedge part 27 is formed to be inclined downwards toward the forward direction from the incident light surface 22 side. Thereby, the thickness of the incident light wedge part 27 tapers from the incident light surface 22 side moving toward the forward direction (in other words, toward the emitting surface 25 side).

The flat part 26 has a constant thickness and is formed such that a top surface 26a which is a surface on the top surface 61 side is substantially orthogonal to the incident light surface 22. The emitting part 28 is formed in a rectangular flat plate shape with a constant thickness and the emitting surface 25 and the underside surface 62, which are flat surfaces that are substantially orthogonal to the incident light surface 22, oppose each other substantially in parallel as the two principal surfaces of the flat plate shape. The emitting surface 25 is formed so as to be connected to an edge 63 that is in the forward direction from the inclined surface 27a.

In addition, on the top surface 61 side of the light guide plate 21, a light blocking sheet (not illustrated) is disposed to cover at least the LEDs 11 and a region of the light guide plate 21 on the incident light surface 22 side (including the flat part 26, the incident light wedge part 27, and a region of the emitting part 28 closer to the incident light wedge part 27). In the spread illuminating apparatus 10, a region of the emitting part 28 that is not covered by the light blocking sheet is set as the effective emitting region E, and light emitted from the effective emitting region E toward the outside among light emitted from the emitting surface 25 is utilized as illumination light.

Further, in the spread illuminating apparatus 10, a plurality of prisms 67 which extend from the incident light surface 22 side of the emitting part 28 toward the end surface side that opposes the incident light surface 22 are provided on the emitting surface 25 of the light guide plate 21. In the present embodiment, as shown in FIG. 2, each prism 67 forms a convex part having an arc-shaped cross-section, and the prisms 67 are repeatedly formed spaced apart by a predetermined distance along the lengthwise direction of the incident light surface 22. In the cross-section shape of each prism 67, for example, the radius is 0.05 mm, the height is 0.017 mm, and the width is 0.06 mm, and the arrangement pitch of the plurality of prisms 67 is, for example, 0.10 mm.

However, in the spread illuminating apparatus 10 according to the present embodiment, the cross-section shape of the prisms 67 is not limited to an arc shape, and can be, for example, any polygonal shape. Also, the height, width, and arrangement pitch of the prisms 67 can be set to any appropriate dimension in accordance with the settings of the diffusing function of the plurality of prisms 67 (to be explained later) and the like. Further, the plurality of prisms 67 are preferably formed in a range including at least the effective emitting region E of the emitting surface 25. However, the range of formation of the plurality of prisms 67 can also be set to any appropriate range in accordance with the settings of the diffusing function of the plurality of prisms 67 (to be explained later) and the like.

Herein, in the spread illuminating apparatus 10, the emitting surface 25, which is a flat surface that is substantially orthogonal to the incident light surface 22 and opposes the underside surface 62 substantially in parallel, corresponds to a plane that constitutes a basal surface of the convex shape of the plurality of prisms 67, or in other words corresponds to a plane including the flat surfaces between adjacent prisms 67 and a virtual bottom surface of each prism 67. However, in the present invention, with regard to emitted light, a combination of light emitted from the flat surfaces between the prisms 67 and light emitted from the top surfaces of the plurality of prisms 67 is collectively referred to as light emitted from the emitting surface 25.

Moreover, the spread illuminating apparatus 10 can include other constituent members (omitted from the drawings) in addition to the constituent members shown in FIG. 1. For example, in the spread illuminating apparatus 10, on the underside surface 62 side of the light guide plate 21, a reflecting sheet can be disposed for returning light that has leaked from the underside surface 62 into the light guide plate 21 again. On the emitting surface 25 side of the emitting part 28, a diffusing sheet and a pair of prism sheets can be successively laminated on each other in order to control the directivity of light that is emitted from the emitting surface 25. The spread illuminating apparatus 10 can also include a frame that accommodates the constituent members.

Further, in the spread illuminating apparatus 10, the LEDs 11 can be disposed/fixed to the incident light surface 22 of the light guide plate 21 by adhering portions which are more forward than the mounting portions of the LEDs 11 of the FPC on which the LEDs 11 are mounted to the light guide plate 21. Therein, if the inclined surface 27a is formed on the top surface 61 side of the incident light wedge part 27 and the FPC is adhered to the top surface side of the light guide plate 21, pedestals for adhering the FPC can be provided on the top surface 61 side of the incident light wedge part 27.

Next, the blue light diffusing part 65 of the spread illuminating apparatus 10 will be explained. In the spread illuminating apparatus 10, the blue light diffusing part 65 that scatters mainly blue light by Rayleigh scattering is provided in a predetermined region near the incident light wedge part 27 on the underside surface 62 of the light guide plate 21. In the present embodiment, the blue light diffusing part 65 is provided along the end of the effective emitting region E on the incident light surface 22 side when viewed from the top surface. The arrangement region thereof is a strip-shaped region including a range of a predetermined distance L in the length direction from the end of the effective emitting region E on the incident light surface 22 side, and a range crossing the entire width of the light guide plate 21 in the width direction. The distance L can be set to, for example, 10 mm in the case that the entire length of the light guide plate 21 is 120 mm.

However, the region in which the blue light diffusing part 65 is to be provided is not limited to the illustrated example, and can include, for example, a region more toward the incident light surface 22 side than the end of the effective emitting region E on the incident light surface 22 side (a region outside of the range of the effective emitting region E).

In the spread illuminating apparatus 10, the blue light diffusing part 65 includes fine bumps which are smaller than the wavelength of blue light (for example, 430 to 490 nm, which is the typical peak wavelength of a blue light-emitting diode used for generating white light). Preferably, the maximum height of the fine bumps included in the blue light diffusing part 65 is smaller than the wavelength of blue light.

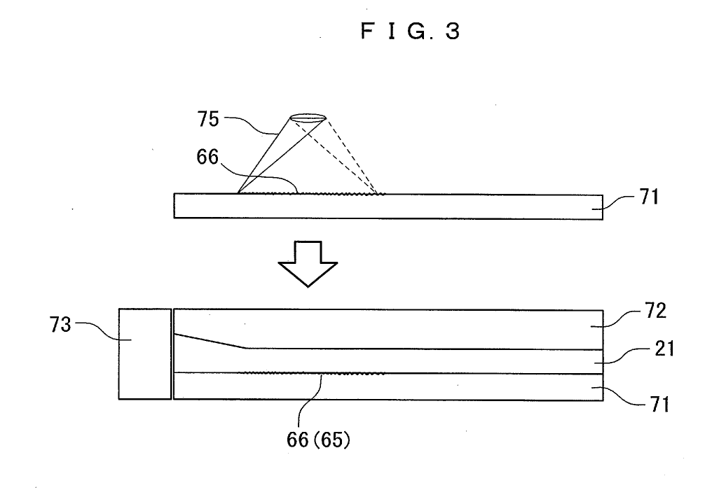

As shown in FIG. 3, the blue light diffusing part 65 including the above-described fine bumps can be provided integrally with the light guide plate 21 by irradiating a laser beam 75 on at least a portion of a region 66 corresponding to the blue light diffusing part 65 of a die 71 for molding the light guide plate 21 to roughen the surface of this portion in the region 66 in which the laser beam 75 has been irradiated and then using the die 71 (and other necessary dies 72 and 73) to mold the light guide plate 21.

However, in the blue light diffusing part 65, the entire region of the die 71 in which the portion whose surface has been roughened is transferred by molding (hereinafter, referred to as the “rough surface part”) does not necessarily have to be constituted by the fine bumps as long as a portion in which fine bumps which are smaller than the wavelength of blue light are formed is included in the rough surface part. For example, the rough surface part can include a structure of bumps which are larger than the wavelength of blue light. Also, the blue light diffusing part 65 can include a region that is not a rough surface part, or in other words a region of the die 71 in which a portion that has not been subjected to additional processing by irradiating the laser beam 75 is transferred (hereinafter, referred to as a “non-additionally processed part”).

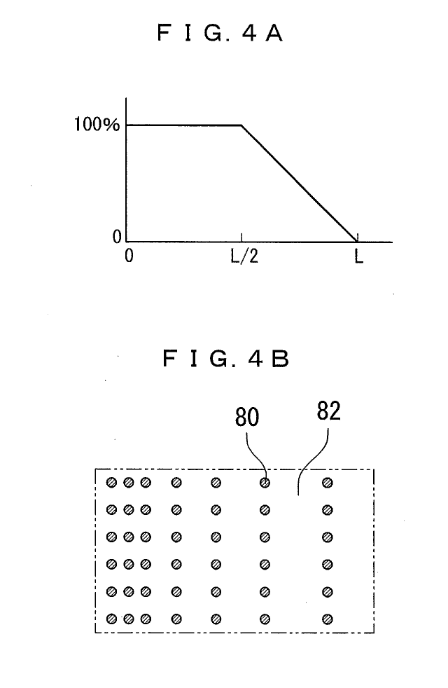

In the spread illuminating apparatus 10, a transition region in which the surface area density of the portions in which fine bumps which are smaller than the wavelength of blue light are formed gradually decreases as moving away from the incident light surface 22 is provided in the blue light diffusing part 65. In more detail, in the spread illuminating apparatus 10, as shown in FIG. 4A, the entire surface of the blue light diffusing part 65 from the end on the incident light surface 22 side to a position at a distance L/2 toward the forward direction is formed as a rough surface part (the surface area density of the rough surface part is 100%). From the distance L/2 to a distance L, which is a position at the end of the blue light diffusing part 65 on the far side from the incident light surface 22, the rough surface parts and the non-additionally processed parts are mixed, and the surface area density of the rough surface parts (in other words, the ratio of the surface area of the rough surface parts relative to the surface area of a fixed range of the blue light diffusing part 65) gradually decreases as the distance increases, and reaches 0% at the distance L.

As shown in FIG. 4B, the change in the surface area density of the rough surface parts in the range from the distance L/2 to the distance L is realized by arranging a plurality of rough surface parts 80 which are formed in dot shapes having the same surface area such that the interval between adjacent rough surface parts 80 increases as the distance increases (in FIG. 4B, intervals 82 between the rough surface parts 80 correspond to non-additionally processed parts 82).

In the spread illuminating apparatus 10, the rough surface parts 80 formed in a dot shape are formed with identical conditions, and the surface area of portions in which fine bumps which are smaller than the wavelength of blue light are formed included in each rough surface part 80 formed in a dot shape is substantially identical. Therefore, in the range from the distance L/2 to the distance L, by configuring the surface area density of the plurality of rough surface parts 80 to gradually decrease as the distance increases as shown in the graph of FIG. 4A, the surface area density of the portions in which the fine bumps are formed also decreases gradually as the distance increases. In these terms, the range of the blue light diffusing part 65 from the distance L/2 to the distance L is a transition region in which the surface area density of the portions in which fine bumps which are smaller than the wavelength of blue light are formed gradually decreases as moving away from the incident light surface 22. Of course, if the entirety of the rough surface parts 80 is constituted by the fine bumps which are smaller than the wave length of blue light, the graph shown in FIG. 4A itself would illustrate the surface area density of the portions in which fine bumps which are smaller than the wavelength of blue light are formed.

The embodiment shown in FIG. 4B is merely one example of an embodiment of the transition region of the blue light diffusing part 65. As long as the surface area density of the portions in which fine bumps which are smaller than the wavelength of blue light are formed gradually decreases as moving away from the incident light surface 22, the shape, size, arrangement pattern, etc. of the rough surface parts 80 in the transition region can be configured in any appropriate way.

Further, for example, if the region in which the blue light diffusing part 65 is provided includes a region more toward the incident light surface 22 side than the end of the effective emitting region E on the incident light surface 22 side, a transition region in which the surface area density of the portions in which fine bumps which are smaller than the wavelength of blue light are formed gradually decreases from the end of the effective emitting region E on the incident light surface 22 side as moving toward the incident light surface 22 can be provided.

Also, in the spread illuminating apparatus according to the present invention, a transition region does not have to be provided in the blue light diffusing part 65, and the surface area density of the portions in which fine bumps which are smaller than the wavelength of blue light are formed can be constant across the entire blue light diffusing part 65.

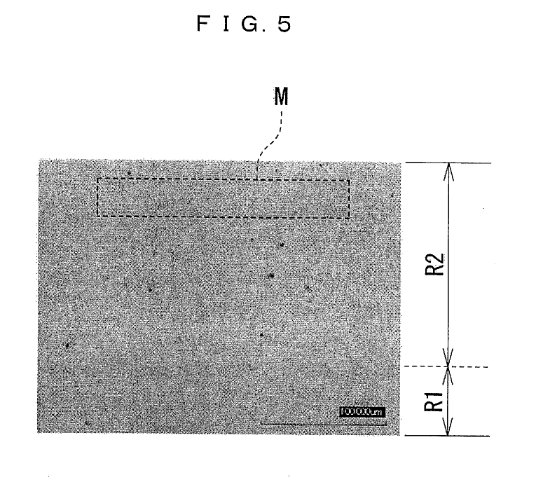

Next, referring to FIG. 5, an example of forming the fine bumps which are smaller than the wavelength of blue light in the blue light diffusing part 65 by the method illustrated in FIG. 3 will be explained. FIG. 5 is an enlarged photograph of a portion of the blue light diffusing part 65 of the light guide plate 21 molded using the die 71 shown in FIG. 3. In FIG. 5, a region R2 on the top side is a region in which portion of the die 71 whose surface has been roughened by irradiation of the laser beam 75 is transferred (corresponding to the rough surface part 80), and a region R1 on the bottom side is a region in which a portion of the die 71 which has not been irradiated by the laser beam 75 is transferred (corresponding to the non-additionally processed part 82).

The parameters of surface roughness measured by a laser microscope in a fixed range M of the region R2 shown in FIG. 5 are given in the table below. In the table, Rp is the maximum peak height of the roughness curves, Rv is a maximum valley depth of the roughness curves, Rz is the maximum height roughness (Rz=Rp+Rv), Ra is the arithmetical average roughness, and Rq is the root mean square roughness. The roughness curves which were used was obtained over approximately 200 μm along the lengthwise direction of the range M. The average values of the parameters calculated upon obtaining multiple roughness curves within the range M are shown in the table below. Also, the same measurements were conducted in the region R1 as well to obtain the surface roughness parameters thereof for comparison.

TABLE 1

| | Rp [μm] | Rv [μm] | Rz [μm] | Ra [μm] | Rq [μm] |
|---|---|---|---|---|---|
| Region R2 | 0.141 | 0.127 | 0.268 | 0.026 | 0.032 |
| Region R1 | 0.070 | 0.063 | 0.123 | 0.015 | 0.018 |

As shown in the above table, the surface roughness parameters of the region R2 are greater than the surface roughness parameters of the region R1 for every parameter, and thus the region R2 has a rougher surface than the region R1. In addition, the surface roughness parameters of the region R2 are less than the wavelength of blue light (for example, 430 to 490 nm) for every parameter, and thus fine bumps which are smaller than the wavelength of blue light are realized. In particular, the maximum height roughness Rz in the region R2 was 0.268 μm (268 nm), which is sufficiently smaller than the wavelength of blue light. Therefore, the fine bumps included in the blue light diffusing part 65 satisfy the condition of being smaller than the wavelength of blue light with respect to the maximum height according to the definition (Rp+Rv) of the maximum height roughness Rz.

In the blue light diffusing part 65 as described above, blue light (for example, the light B whose optical path is schematically illustrated in FIG. 1) among light which has entered into the portion in which fine bumps which are smaller than the wavelength of blue light are formed is scattered by Rayleigh scattering, in which the scattering coefficient is inversely proportional to the fourth power of the wavelength, at a higher scattering intensity compared to light of longer wavelengths than that of blue light (for example, the light Y whose optical path is schematically illustrated in FIG. 1). Therein, the majority of light of longer wavelengths than that of blue light follows the same optical path as the case in which there are no fine bumps and the light is not scattered (in other words, total reflection by the underside surface 62) and is sent first toward the forward direction of the light guide plate 21. Also, in the blue light diffusing part 65, the characteristics of scattering and reflection of light that has entered into the non-additionally processed parts 82 and the portions of the rough surface parts 80 in which fine bumps which are smaller than the wavelength of blue light are not formed, if such portions exist, are not remarkably wavelength dependent. Therefore, the blue light diffusing part 65 has overall scattering characteristics in which it scatters mainly blue light.

The operational effects of the spread illuminating apparatus 10 constituted as described above will now be explained as follows.

First, in the spread illuminating apparatus 10, the blue light diffusing part (light diffusing part) 65, which scatters mainly blue light (light emitted by the light-emitting diode 41) which has a wavelength that is shorter than that of yellow light (light emitted by the fluorescent bodies) by Rayleigh scattering in which the scattering coefficient is inversely proportional to the fourth power of the wavelength, is provided near the incident light wedge part 27. Thereby, blue light that is emitted upon being scattered by the blue light diffusing part 65 is supplemented into the light that is emitted from a region of the emitting part 28 closer to the incident light wedge part 27. Thus, visible light unevenness caused by the region of the emitting part 28 closer to the incident light wedge part 27 exhibiting a yellow tint can be suppressed, and in turn, the color tone uniformity of light emitted from the light guide plate can be enhanced.

Further, in the spread illuminating apparatus 10, the blue light diffusing part 65 is provided along the end of the effective emitting region E on the incident light surface 22 side when viewed from the top surface. Thereby, the color tone uniformity of light emitted from the effective emitting region E, which is important for the quality of illumination light, can be effectively enhanced.

Also, in the spread illuminating apparatus 10, the blue light diffusing part 65 includes fine bumps which are smaller than the wavelength of blue light (and whose surface roughness is higher than that of the non-additionally processed parts 82), and these fine bumps effectively achieve Rayleigh scattering. Thereby, blue light can be scattered at a higher scattering intensity compared to light of wavelengths longer than that of blue light. In addition, the maximum height of the fine bumps included in the blue light diffusing part 65 is smaller than the wavelength of blue light (but larger than the maximum height of the non-additionally processed parts 82). Therefore, these fine bumps more reliably cause Rayleigh scattering, and thus the amount of blue light that is scattered by the blue light diffusing part can be further increased.

Furthermore, in the spread illuminating apparatus 10, the blue light diffusing part 65 includes a transition region in which the surface area density of the portions in which fine bumps are formed gradually decreases as moving away from the incident light surface. Thereby, sudden changes in the chromaticity of light emitted from the emitting surface 25 near a boundary between the region of the emitting part 28 in which the blue light diffusing part 65 is provided and the region of the emitting part 28 in which the blue light diffusing part 65 is not provided (in other words, the end of the blue light diffusing part 65 on the opposite side of the incident light surface 22 side) are suppressed. Thus, the color tone uniformity of emitted light can be further enhanced.

Moreover, in the spread illuminating apparatus 10, the blue light diffusing part 65 is formed by molding the light guide plate 21 using the die 71 in which a laser beam has been irradiated on the region 66 corresponding to the blue light diffusing part 65. This is advantageous because, by controlling the power, irradiation time, and irradiation region of the laser beam 75 irradiated during processing of the die, the blue light diffusing part (light diffusing part) 65 having the desired scattering characteristics corresponding to the desired chromaticity can be easily formed.

Herein, a light L1 (refer to FIG. 10), which has a strong yellow tint and is emitted from the LEDs 11 used in the spread illuminating apparatus 10 in a direction in which the angle that forms the optical axis thereof is large, enters directly, or after being reflected once at the top surface 61 side, into the inclined surface 27a of the incident light wedge part 27 at a small incident angle. Therefore, it is subsequently guided while being reflected one or more times between the top surface 61 side and the underside surface 62 side without being directly guided into the emitting part 28, and enters into the emitting surface 25 at an incident angle that is smaller than a critical angle on the incident light surface 22 side of the effective emitting region E of the emitting surface 25 and is then emitted from that position.

Accordingly, when using LEDs 11 that have a structure in which a blue light-emitting diode 41 is enclosed in a transparent resin 42 in which yellow fluorescent bodies are dispersed as in the LEDs 11, the effect of suppressing a yellow tint achieved by supplementing blue light by the blue light diffusing part 65 is more prominently achieved.

Also, in the case that the spread illuminating apparatus includes a structure in which a plurality of prisms 67 extending from the incident light surface 22 side of the emitting part 28 toward the end surface side opposing the incident light surface 22 are provided on the emitting surface 25 side of the light guide plate 21, as in the spread illuminating apparatus 10, the occurrence of bright lines can be suppressed and the brightness uniformity can be increased even if a point light source such as the LED 11 is used as a light source. On the other hand, a yellow tint of light emitted from the region of the emitting part 28 closer to the incident light wedge part 27 tends to become stronger. This is believed to be because, among the light emitted from the LEDs 11, light that is emitted in a direction along the lengthwise direction of the incident light surface 22 (a direction in which the angle that forms the optical axis thereof is large) when viewing the spread illuminating apparatus 10 from the emitting surface 25 side has a strong yellow tint similar to the light L1 shown in FIG. 10 and easily enters into the side surfaces of the prisms 67 at an incident angle that is smaller than a critical angle in the region of the emitting part 28 closer to the incident light wedge part 27.

Therefore, in the spread illuminating apparatus 10, which uses LEDs 11 that have a structure in which the blue light-emitting diode 41 is enclosed in the transparent resin 42 in which yellow fluorescent bodies are dispersed as in the LEDs 11 and has a structure in which the plurality of prisms 67 extending from the incident light surface 22 side of the emitting part 28 toward the end surface side opposing the incident light surface 22 are provided, the effect of suppressing a yellow tint achieved by supplementing blue light by the blue light diffusing part 65 is even more prominently achieved.

However, the white light source of the spread illuminating apparatus according to the present invention is not limited to the LEDs 11. For example, the light source of the spread illuminating apparatus according to the present invention can be an LED having a structure in which a blue light-emitting diode 41 is enclosed in a transparent resin in which fluorescent bodies that convert to light of a different color than yellow having a longer wavelength than that of blue light (for example, green fluorescent bodies and red fluorescent bodies) are dispersed. In this case, remarkable effects similar to those of the spread illuminating apparatus 10 including the LEDs 11 are achieved.

Further, regardless of the type of light source, as long as it emits white light, the emission spectrum of the light source can include a light component included in the wavelength range of blue light and a light component included in a wavelength range of wavelengths longer than that of blue light. Therefore, the structure including blue light diffusing part 65 of the spread illuminating apparatus according to the present invention achieves a constant effect for suppressing incident light color unevenness.

For example, the light source of the spread illuminating apparatus according to the present invention can be an LED including a plurality of different types of light-emitting elements (typically a blue light-emitting diode, a green light-emitting diode, and a red light-emitting diode). Also, in a light source constituted by a light-emitting element of a single color and a wavelength converting material, the wavelength converting material can be a quantum dot.

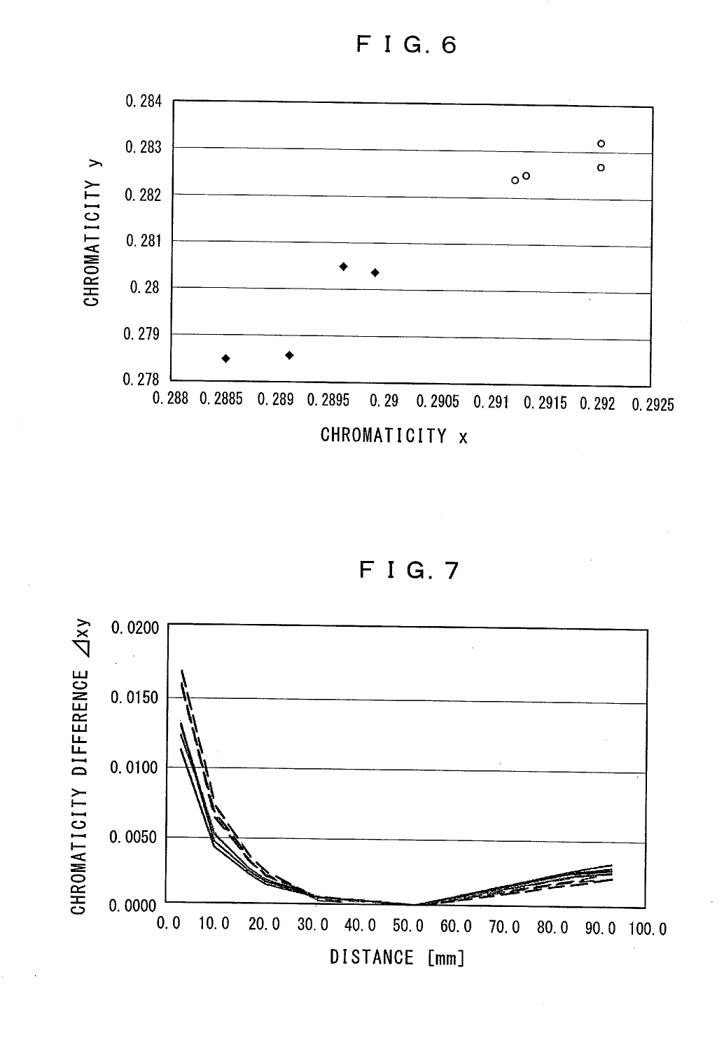

Next, referring to FIGS. 6 and 7, the results upon measuring the chromaticity of emitted light in the spread illuminating apparatus 10 will be explained along with a comparative embodiment. Herein, FIG. 6 is a graph illustrating the color of light emitted at a measurement point closest to the incident light surface 22 side of the effective emitting region E on the light guide plate 21 as coordinates (x, y) on an xy chromaticity diagram of the CIE color specification in the spread illuminating apparatus 10 and a spread illuminating apparatus according to a comparative embodiment. The spread illuminating apparatus according to the comparative embodiment has the same structure as that of the spread illuminating apparatus 10 except that it lacks the blue light diffusing part 65. Also, the position of the measurement point is a position at a distance of approximately 2 mm toward the forward direction from the end of the effective emitting region E on the incident light surface 22 side.

In FIG. 6, the measurement values of four test samples corresponding to the spread illuminating apparatus 10 are illustrated with black-filled diamonds, and the measurement values of four test samples corresponding to the spread illuminating apparatus according to the comparative embodiment are illustrated with white circles.

As can be understood from FIG. 6, the measurement values of the four test samples corresponding to the spread illuminating apparatus 10 all exhibit smaller values for both the chromaticity x and the chromaticity y compared to the four test samples corresponding to the spread illuminating apparatus according to the comparative embodiment. A decrease in the values of both the chromaticity x and the chromaticity y in this way indicates that the yellow tint of the emitted light is reduced and the blue tint is increased. These results demonstrate that in the spread illuminating apparatus 10 including the blue light diffusing part 65, color unevenness due to the yellow tint is suppressed as a result of supplementing blue light into the light that is emitted from the incident light surface 22 side of the effective emitting region E.

FIG. 7 is a graph illustrating a chromaticity difference Δxy from a chromaticity at a reference point of emitted light across the effective emitting region E on the light guide plate 21 relative to a distance in the light guide direction from a position in the effective emitting region E that is closest to the incident light surface 22 side as a starting point in the spread illuminating apparatus 10 and the spread illuminating apparatus according to the comparative embodiment. The spread illuminating apparatus according to the comparative embodiment has the same structure as that of the spread illuminating apparatus 10 except that it lacks the blue light diffusing part 65. The reference point is a measurement point at which the blue tint in the chromaticity of the emitted light is the strongest (in the illustrated example, a measurement point near the center in the light guide direction of the effective emitting region E). When the coordinates on the xy chromaticity diagram of the chromaticity at the reference point are (x0, y0) and the coordinates on the xy chromaticity diagram of the chromaticity at each measurement point are (x, y), the chromaticity difference Δxy at each measurement point is calculated by Δxy=√((x0−x)²+(y0−y)²) for each measurement point.

In FIG. 7, the measurement values of a plurality of test samples corresponding to the spread illuminating apparatus 10 are illustrated with solid lines, and the measurement values of a plurality of test samples corresponding to the spread illuminating apparatus according to the comparative embodiment are illustrated with dashed lines.

As can be understood from FIG. 7, the chromaticity difference Δxy of the plurality of test samples corresponding to the spread illuminating apparatus 10 increases approaching the starting point from near a distance of 30 mm. However, the rate of increase is smaller in all of the test samples corresponding to the spread illuminating apparatus 10 compared to all of the test samples corresponding to the spread illuminating apparatus according to the comparative embodiment. For example, the chromaticity difference Δxy in the test samples corresponding to the spread illuminating apparatus 10 at the measurement point in the effective emitting region E that is closest to the incident light surface 22 side was only 0.03 to 0.05 less than that in the test samples corresponding to the spread illuminating apparatus according to the comparative embodiment. On the other hand, as the distance from the reference point increases, there is no notable difference between the chromaticity difference Δxy of the spread illuminating apparatus 10 and that of the comparative embodiment. These results demonstrate that in the spread illuminating apparatus 10 including the blue light diffusing part 65, color tone uniformity is enhanced across the entire length of the effective emitting region E as a result of supplementing blue light into the light that is emitted from the incident light surface 22 side of the effective emitting region E.

A preferred embodiment of the present invention was explained above, but the present invention is not limited to this embodiment and various modifications and combinations are possible within a scope that does not deviate from the gist of the present invention.

The inclined surface 27a of the incident light wedge part 27 can be provided on the underside surface 62 side instead of the top surface 61 side (the emitting surface 25 side). Alternatively, the inclined surface 27a can be provided on both the top surface 61 side and the underside surface 62 side. In all of these cases, i.e., if the inclined surface 27a is provided on only the top surface 61 side, or is provided on only the underside surface 62 side, or is provided on both the top surface 61 side and the underside surface 62 side, the shape of the inclined surface 27a does not have to be a flat surface that inclines with a constant gradient, and, for example, it can include a curved surface or multiple flat surfaces having different gradients.

Also, the spread illuminating apparatus 10 can include a plurality of blue light diffusing parts 65. Further, the blue light diffusing part 65 can also be provided on the top surface 61 side of the light guide plate, or provided on both the top surface 61 side and the underside surface 62 side. In addition, at least one blue light diffusing part 65 can be provided on the inclined surface 27a of the incident light wedge part 27, or provided on the top surfaces of the prisms 67 in the case that a plurality of the prisms 67 are provided on the emitting part 28.

Further, in the spread illuminating apparatus 10, the rough surface in the die for molding the light guide plate 21 can be formed by a method other than laser beam irradiation (such as sandblasting or various etching methods) in the region 66 corresponding to the blue light diffusing part 65. Also, the blue light diffusing part 65 does not have to be transferred from a die for molding, and can instead be provided by directly processing the light guide plate 21.

In addition, the blue light diffusing part 65 does not have to be provided in a strip shape across the entire width of the light guide plate 21, and can be provided in a plurality of small portions arranged with intervals therebetween along the width direction of the light guide plate 21. These small portions can be arranged in front of the LEDs 11, or arranged on the sides of the LEDs 11 (for example, in front of the intervals between adjacent LEDs 11).

What is claimed is:

1. A spread illuminating apparatus comprising:
a light source that emits white light, and
a light guide plate including an incident light surface which is an end surface at which the light source is disposed and an emitting part that emits light which has entered from the incident light surface in a spread pattern from an emitting surface which is one principal surface,
wherein the light guide plate includes an incident light wedge part between the incident light surface and the emitting part, the incident light wedge part including an inclined surface tapering in thickness from the incident light surface side toward a forward direction, and
a blue light diffusing part that scatters mainly blue light by Rayleigh scattering is provided on at least one of the emitting surface side or an opposite surface side of the emitting surface side near the incident light wedge part.

2. The spread illuminating apparatus according to claim 1, wherein the blue light diffusing part includes fine bumps which are smaller than the wavelength of blue light.

3. The spread illuminating apparatus according to claim 2, wherein the maximum height of the fine bumps is smaller than the wavelength of blue light.

4. The spread illuminating apparatus according to claim 1, wherein the blue light diffusing part is provided along an end of an effective emitting region on the incident light surface side when viewed from the top surface.

5. The spread illuminating apparatus according to claim 2, wherein a transition region is configured as that a surface area density of portions in which the fine bumps are formed gradually decreases as moving away from the incident light surface.

6. The spread illuminating apparatus according to claim 1, wherein the blue light diffusing part is formed by molding the light guide plate using a die in which a laser beam has been irradiated on a region corresponding to the blue light diffusing part.

7. The spread illuminating apparatus according to claim 1, wherein the light source includes a light-emitting element and fluorescent bodies, the fluorescent bodies being configured to receive light that is emitted by the light-emitting element, and
wherein the fluorescent bodies are allowed to emit light that is different from the light that has been emitted by the light-emitting element.

8. The spread illuminating apparatus according to claim 1, wherein the light-emitting element is a blue light-emitting diode that emits blue light, and the fluorescent bodies are yellow fluorescent bodies that emit yellow light.

9. The spread illuminating apparatus according to claim 7, wherein the fluorescent bodies are dispersed in an enclosure that covers the light-emitting element.

10. The spread illuminating apparatus according to claim 8, wherein the fluorescent bodies are dispersed in an enclosure that covers the light-emitting element.

11. The spread illuminating apparatus according to claim 1, wherein a plurality of prisms extending from the incident light surface side of the emitting part toward an end surface side opposing the incident light surface are provided on the emitting surface side of the light guide plate.

12. A spread illuminating apparatus comprising:
a light source that includes a light-emitting diode and fluorescent bodies, the light source emitting white light, and
a light guide plate including an incident light surface which is an end surface at which the light source is disposed and an emitting part that emits light which has entered from the incident light surface in a spread pattern, the light being emitted from an emitting surface which is one principal surface,
wherein the light guide plate includes an incident light wedge part between the incident light surface and the emitting part, the incident light wedge part including an inclined surface and tapering in thickness from the incident light surface side toward a forward direction, and
a light diffusing part that scatters mainly light emitted by the light-emitting diode more than light emitted by the fluorescent bodies is provided on at least one of the emitting surface side or an opposite surface side of the emitting surface side near the incident light wedge part.
